(19) United States
(12) Patent Application Publication
(10) Pub. No.: US 2019/0207494 A1
(43) Pub. Date: Jul. 4, 2019

(54) MOTOR AND MOTOR WINDING METHOD

(71) Applicant: Mitsubishi Electric Corporation, Tokyo (JP)

(72) Inventor: Hiroyuki OGURA, Tokyo (JP)

(73) Assignee: Mitsubishi Electric Corporation, Tokyo (JP)

(21) Appl. No.: 16/311,637

(22) PCT Filed: Aug. 25, 2016
(86) PCT No.: PCT/JP2016/074821

§ 371 Date: Dec. 19, 2018

(51) Int. Cl. H02K 23/38; H02K 15/00

(52) U.S. Cl. CPC H02K 23/38; H02K 15/0068

(57) ABSTRACT

A wire material is hooked to a commutator segment and a commutator segment to form an equalizing line therebetween, and the wire material is wound in a distributed manner between a slot and a slot to form a main winding. Subsequently, the wire material is hooked to a commutator segment and a commutator segment to form an equalizing line therebetween, and the wire material is wound in a distributed manner between a slot and a slot to form a main winding. As described above, a process of forming the equalizing line and a process of forming the main winding are repeated while changing the commutator segment to which hooking is to be performed and the slot in which the main winding is to be formed until the number of times of hooking to one commutator segment becomes the same number for all the commutator segments and the number of times the main winding is formed in one slot becomes the same number for all the slots.

### TECHNICAL FIELD

The present invention relates to a motor, and especially relates to a rotor winding thereof.

### BACKGROUND ART

For example, Patent Literature 1 discloses a DC brush motor in which coils are manufactured by sequentially forming in a circumferential direction a plurality of repeatedly-winding portions. Each of the plurality of repeatedly-winding portions is formed of a wire. The wire starts from a first joint portion being a hook formed on one element out of elements forming a commutator, then is introduced in a first inter-teeth space being an inter-teeth space of the same phase as the first joint portion, then is wound repeatedly over three teeth, then is taken from a second inter-teeth space being an inter-teeth space adjacent to the first inter-teeth space, and ends at a second joint portion being a hook formed on an element of the same phase as the second inter-teeth space.

Also, in such a motor, in addition to repeatedly winding on the teeth, it is necessary to arrange an equalizing line in order to make elements of the commutator located diagonally the same potential.

### CITATION LIST

### Patent Literatures

### SUMMARY OF INVENTION

### Technical Problem

In a winding process in a motor, as the number of times a wire material is cut increases, it takes more time to finish the process. In addition, when the number of times of hooking increases with cutting of the wire material, possibility of making a mistake in hooking also increases, and thus quality is not stable.

Patent Literature 1 described above discloses that when the second joint portion is set as the first joint portion of a next repeatedly-winding portion, the wire may be continuous without being cut. However, the equalizing line is not especially disclosed, and thus the equalizing line is arranged separately from the repeatedly-winding portions. In addition, since the first joint portion of the first repeatedly-winding portion is the second joint portion of the 12th repeatedly-winding portion, hooking is performed twice only for the first joint portion of the first repeatedly-winding portion when the repeatedly-winding portions are formed by making the wire continuous. A hooking portion is finally joined by fusing. When states of hooking are different, it is necessary to change setting of fusing each time, so that a process thereof becomes complicated and the quality is not stable.

The present invention is achieved to solve the above problems, and an object thereof is to obtain a motor in which the number of times a wire material is cut at the time of a winding process can be suppressed and fusing can be performed with the same setting to each hooking portion.

### Solution to Problem

A motor according to the present invention is provided with a rotatable shaft, a rotor core including a plurality of teeth which are provided side by side in a circumferential direction with respect to a rotation axis direction of the shaft, a plurality of slots being formed between respective pairs of the adjacent teeth, the rotor core fixed to the shaft, a commutator including a plurality of commutator segments which are as many as the plurality of teeth and provided side by side in the circumferential direction with respect to the rotation axis direction of the shaft, the commutator fixed to the shaft, an equalizing line that connects diagonally located commutator segments out of the plurality of commutator segments, and a main winding wound between each of the plurality of slots and another one of the slots in a distributed manner, in which an equalizing line is hooked to each of the plurality of commutator segments the same number of times, and the equalizing line and the main winding are integrally formed of one continuous wire material.

### Advantageous Effects of Invention

According to the present invention, since a main winding between slots and an equalizing line connecting commutator segments are formed of one wire material, the number of times the wire material is cut at the time of a winding process is suppressed. Also, since the number of times of hooking to each of all the commutator segments is the same, it is possible to perform fusing with the same setting.

### BRIEF DESCRIPTION OF DRAWINGS

FIG. 1 is a cross-sectional view illustrating a motor according to a first embodiment of the present invention.

FIG. 2 is a planar view selectively illustrating a commutator and a rotor core as seen from a direction A in FIG. 1.

FIG. 3 is a view schematically illustrating the commutator and the rotor core and illustrating states of main windings.

FIG. 4 is a view for illustrating the order of winding.

FIG. 5 is a view illustrating a state of winding while developing commutator segments and slots in a circumferential direction.

FIG. 6 is a view illustrating states of main windings of a first reference example for assisting understanding of the motor according to the first embodiment of the present invention.

FIG. 7 is a view for illustrating the order of winding in the first reference example illustrated in FIG. 6.

FIG. 8 is a view illustrating states of main windings of a second reference example for assisting understanding of the motor according to the first embodiment of the present invention.

FIG. 9 is a view for illustrating the order of winding in the second reference example illustrated in FIG. 8.

FIG. 10 is a view illustrating states of main windings of a first variation of the motor according to the first embodiment of the present invention.

FIG. 11 is a view for illustrating the order of winding in the first variation illustrated in FIG. 10.

FIG. 12 is a view illustrating states of main windings of a third reference example for assisting understanding of the motor according to the first embodiment of the present invention.

FIG. 13 is a view for illustrating the order of winding in the third reference example illustrated in FIG. 12.

FIG. 14 is a view illustrating states of main windings of a second variation of the motor according to the first embodiment of the present invention.

FIG. 15 is a view for illustrating the order of winding in the second variation illustrated in FIG. 14.

FIG. 16 is a view illustrating states of main windings of a fourth reference example for assisting understanding of the motor according to the first embodiment of the present invention.

FIG. 17 is a view for illustrating the order of winding in the fourth reference example illustrated in FIG. 16.

### DESCRIPTION OF EMBODIMENTS

A mode for carrying out the present invention is hereinafter described with reference to the attached drawings in order to describe the present invention in more detail.

### First Embodiment

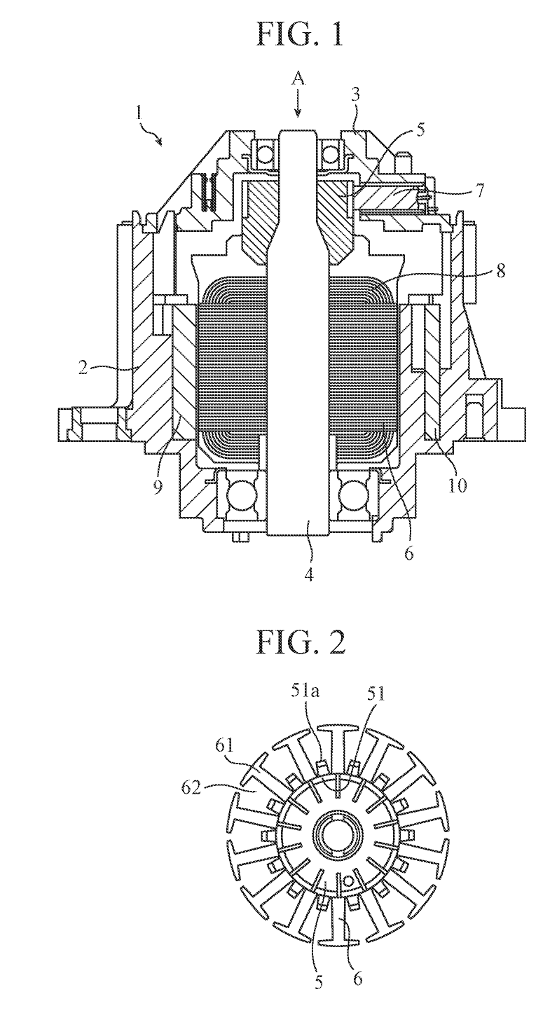

FIG. 1 is a cross-sectional view illustrating a motor 1 according to a first embodiment of the present invention. The motor 1 is a distributed winding DC motor with brush.

A shaft 4 is rotatably supported in a space surrounded by a case 2 and a brush holder 3. A commutator 5 and a rotor core 6 having a stacked structure are fixed to the shaft 4.

The commutator 5 is in partial contact with a brush 7 supported by the brush holder 3.

A coil 8 is formed on the rotor core 6. A magnet 9 and a yoke 10 supported by the case 2 are provided on an outer peripheral side as seen from the rotor core 6.

Herein, FIG. 2 selectively illustrates the commutator 5 and the rotor core 6 as seen from a direction A in FIG. 1.

The commutator 5 includes a total of 14 commutator segments 51 in the illustrated example. Each of a plurality of commutator segments 51 provided side by side in a circumferential direction with respect to a rotation axis direction of the shaft 4 includes a hook-shaped hook 51a facing an outer periphery.

The rotor core 6 includes a plurality of substantially T-shaped teeth 61 extending from the center to the outer periphery. In the illustrated example, a plurality of teeth 61 as many as the commutator segments 51, 14 in total, is provided side by side in the circumferential direction with respect to the rotation axis direction of the shaft 4. A space is formed as a slot 62 between two adjacent teeth 61.

In the motor 1, a second case not illustrated on which a connector is formed is attached to the case 2 so as to interpose the brush holder 3. When direct current is externally supplied via the connector, the direct current is supplied to the coil 8 via the brush 7 and then the commutator 5, whereby the shaft 4, the commutator 5, the rotor core 6, and the coil 8 integrally rotate.

Note that the number of a plurality of commutator segments 51 and the number of a plurality of teeth 61 are not limited to those in the illustrated example. Also, a positional relationship between a plurality of commutator segments 51 and a plurality of teeth 61 is not limited to that in the illustrated example. In the illustrated example, the hook 51a of the commutator segment 51 is located so as to overlap with the slot 62, but the hook 51a of the commutator segment 51 may be located so as to overlap with the tooth 61. The positional relationship between a plurality of commutator segments 51 and a plurality of teeth 61 varies depending on arrangement of the brush 7, the magnet 9 and the like which are fixed in contrast to the commutator 5, the rotor core 6 and the like which rotate.

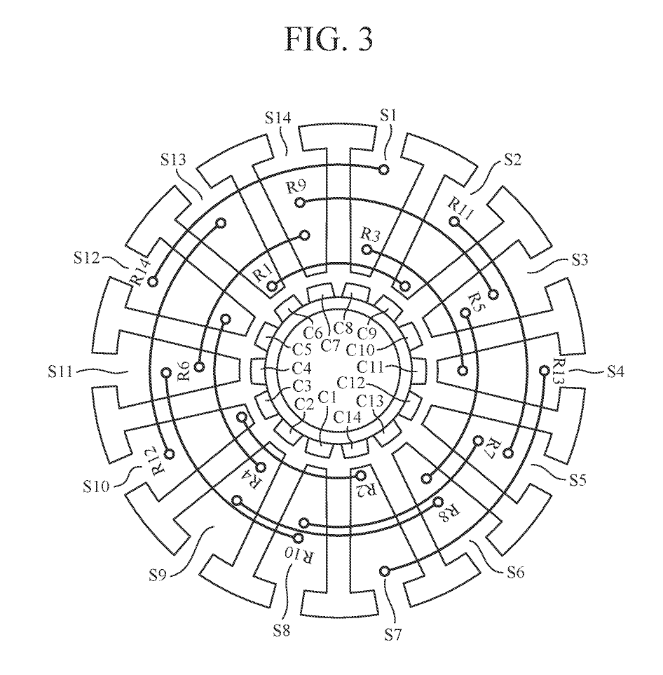

Next, a winding process in the motor 1 is described with reference to FIGS. 3, 4, and 5.

FIG. 3 schematically illustrating FIG. 2 is a view illustrating states of main windings. For the sake of description, a total of 14 commutator segments 51 are distinguished as commutator segments C1 to C14, and similarly, a total of 14 slots 62 are distinguished as slots S1 to S14.

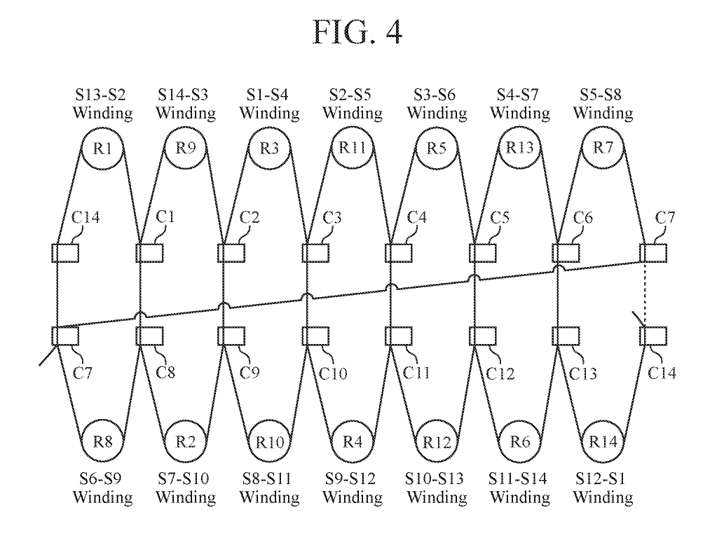

FIG. 4 is a view for illustrating the order of winding.

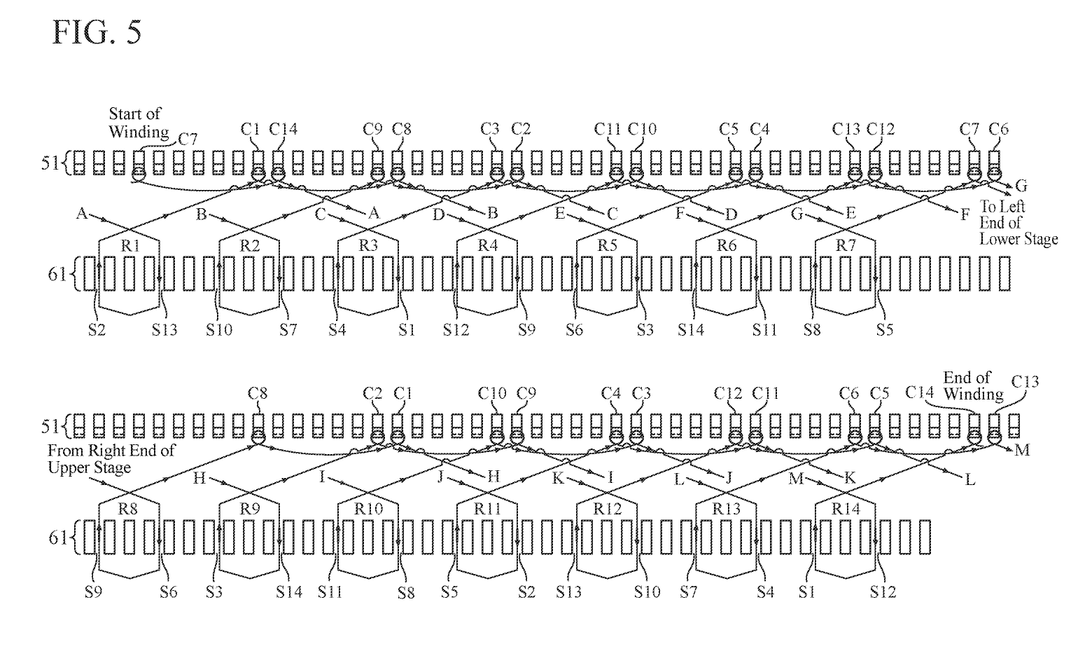

FIG. 5 is a view illustrating a state of winding while developing the commutator segments 51 and the slots 62 in the circumferential direction.

Note that, in FIG. 5, reference signs of the commutator segments C1 to C14 and reference signs of the slots S1 to S14 are omitted in some places for convenience of the drawing. Since the commutator segments 51 and the slots 62 illustrated in FIG. 5 are developed in the circumferential direction to be arranged as described above, the commutator segments C6, C5, C4, C3, and C2 are arranged in this order on the right side of the commutator segment C7 from which the winding is started. Similarly, the slots S12 and S11 are arranged in this order on the right side of the slot S13 where a main winding R1 extends.

First, a wire material such as a wire is hooked to any one of the commutator segments C1 to C14, the commutator segment C7 in the illustrated example, to start winding. In detail, the wire material is hooked to the hook 51a of the commutator segment C7. Hereinafter, hooking to the commutator segment means hooking to the hook 51a of the commutator segment.

Subsequently, the wire material is passed to the commutator segment C14 located diagonally to the commutator segment C7, and the wire material is hooked to the commutator segment C14 to form an equalizing line between the commutator segment C7 and the commutator segment C14 to connect them. Diagonal positions refer to positions separated by 180 degrees, that is, positions which make the center of the commutator 5 sandwiched therebetween.

Subsequently, the wire material is passed from the commutator segment C14, and this is wound repeatedly between the slot S13 and the slot S2, for example, by 73 turns. As a result, a main winding which is a distributed winding over three teeth 61 is formed. This main winding is illustrated as the main winding R1.

Subsequently, the wire material is passed from the main winding R1 to the commutator segment C1 and hooked to the commutator segment

Subsequently, the wire material is passed to the commutator segment C8 located diagonally to the commutator segment C1 and is hooked to the commutator segment C8 to form an equalizing line between the commutator segment C1 and the commutator segment C8.

Subsequently, the wire material is passed from the commutator segment C8, and this is wound repeatedly between the slot S7 and the slot S10 to form a main winding R2 which is a distributed winding. The main winding R2 is formed between the slot S7 and the slot S10 located in positions shifted in the circumferential direction from the slot S6 and the slot S9 located diagonally to the two slots S13 and S2 through which the main winding R1 previously formed passes. In the illustrated example, the slots S7 and S10 are located in positions shifted clockwise by one tooth from the slots S6 and S9, respectively.

This is because, in a case where the wire material is passed from the commutator segment C8 and a main winding is formed between the slots S6 and S9 located diagonally to the main winding R1, an equalizing line is formed again between the commutator segment C7 and the commutator segment C14, so that the number of times of hooking to the commutator segment C7 and the number of times of hooking to the commutator segment C14 increase as compared with that to each of other commutator segments.

Subsequently, a process similar to the above-described method of passing the wire material from the commutator segment C1 to the commutator segment C8 and then to the slot S7 and the slot S10 is repeated.

Specifically, the wire material is passed from the main winding R2 to the commutator segment C9 and then to the commutator segment C2, and thereafter a main winding R3 is formed between the slot S1 and the slot S4. Subsequently, the wire material is passed from the main winding R3 to the commutator segment C3 and then to the commutator segment C10, and thereafter a main winding R4 is formed between the slot S9 and the slot S12. Subsequently, the wire material is passed from the main winding R4 to the commutator segment C11 and then to the commutator segment C4, and thereafter a main winding R5 is formed between the slot S3 and the slot S6. Subsequently, the wire material is passed from the main winding R5 to the commutator segment C5 and then to the commutator segment C12, and thereafter a main winding R6 is formed between the slot S11 and the slot S14. Subsequently, the wire material is passed from the main winding R6 to the commutator segment C13 and then to the commutator segment C6, and thereafter a main winding R7 is formed between the slot S5 and the slot S8.

In the processes so far, the main winding is formed once for each of the slots S1 to S14, and hooking is performed once for each of the commutator segments C1 to C14. In this state, the formed equalizing line and main winding are integrally formed of one continuous wire material without being cut in the middle.

Note that, in order to further increase rotational force of the motor 1, the main winding is further formed once for each of the slots S1 to S14, thus forming the main winding twice for each slot. Note that, in this case, the main winding is formed between one slot and each of two different slots. As illustrated in FIG. 3, it is a state, for example, in which the main winding is formed once between the slot S1 and the slot S4 and once between the slot S1 and the slot S12.

A process of further forming the main winding once for each of the slots S1 to S14 is described below.

After forming the main winding R7, the wire material is passed from the main winding R7 to the commutator segment C7 and hooked to the commutator segment C7.

Subsequently, the wire material is passed from the commutator segment C7, and this is wound repeatedly between the slots S6 and S9 to form a main winding R8 which is a distributed winding.

Subsequently, the wire material is passed from the main winding R8 to the commutator segment C8 and then to the commutator segment C1 located diagonally to the commutator segment C8 to form an equalizing line between the commutator segment C8 and the commutator segment C1.

Subsequently, the wire material is passed from the commutator segment C1, and this is wound repeatedly between the slot S14 and the slot S3 to form a main winding R9 which is a distributed winding. The main winding R9 is formed between the slot S14 and the slot S3 located in positions shifted in the circumferential direction from the slot S13 and the slot S2 located diagonally to the two slots S6 and S9 through which the main winding R8 previously formed passes. In the illustrated example, those are positions shifted clockwise by one tooth.

Subsequently, a process similar to the above-described method of passing the wire material from the commutator segment C8 to the commutator segment C1 and then to the slots S14 and S3 is repeated.

Specifically, the wire material is passed from the main winding R9 to the commutator segment C2 and then to the commutator segment C9, and thereafter a main winding R1O is formed between the slot S8 and the slot S11. Subsequently, the wire material is passed from the main winding R10 to the commutator segment C10 and then to the commutator segment C3, and thereafter a main winding R11 is formed between the slot S2 and the slot S5. Subsequently, the wire material is passed from the main winding R11 to the commutator segment C4 and then to the commutator segment C11, and thereafter a main winding R12 is formed between the slot S10 and the slot S13. Subsequently, the wire material is passed from the main winding R12 to the commutator segment C12 and then to the commutator segment C5, and thereafter a main winding R13 is formed between the slot S4 and the slot S7. Subsequently, the wire material is passed from the main winding R13 to the commutator segment C6 and then to the commutator segment C13, and thereafter a main winding R14 is formed between the slot S12 and the slot S1.

Then, the wire material is passed from the main winding R14 to the commutator segment C14 to be hooked, and the winding is finished.

In the processes so far, the main winding is formed twice for each of the slots S1 to S14, and hooking is performed twice for each of the commutator segments C1 to C14. In this state, as illustrated in FIGS. 4 and 5, the equalizing line and the main winding formed by starting winding at the commutator segment C7 and finishing winding at the commutator segment C14 are integrally formed of one continuous wire material without being cut in the middle.

A broken line connecting the commutator segment C7 and the commutator segment C14 located at the right end in FIG. 4 indicates an equalizing line drawn with solid line and connecting the commutator segment C7 and the commutator segment C14 located at the left end in FIG. 4.

Note that a target slot 62 for which the main winding is formed after hooking the wire material to the commutator segment 51 is not limited to that in the illustrated example because a desirable slot 62 varies depending on the arrangement of the brush 7, the magnet 9 and the like.

Also, the order of forming the equalizing line on each of the commutator segments 51, the order of forming the main winding in each of the slots 62 and the like are not limited to those in the illustrated example. In the illustrated example, a case in which the commutator segment 51 is selected so that the equalizing line is formed in the order as regular as possible, and the slot 62 is selected so that the main winding is formed in the order as regular as possible is taken as an example. However, in short, it is sufficient that the equalizing line and the main winding are formed of one wire material in a state in which the equalizing line is hooked the same number of times to each of all the commutator segments 51 and the main winding is formed the same number of times for each of all the slots 62. In the above description, for this purpose, a first process of forming the equalizing line between two diagonally located commutator segments 51 and a second process of forming the main winding between two slots 62 are repeated until the number of times of hooking to one commutator segment 51 becomes the same number for all the commutator segments 51 and the number of times of the main winding is formed in one slot 62 becomes the same number for all the slots 62 while changing the commutator segment 51 to which the wire material is to be hooked and the slot 62 in which the main winding is to be formed.

A portion of the wire material having a substantially arc-circular shape in a planar view in FIG. 3 is a portion orthogonal to the shaft 4 which is the rotation axis of the motor 1, and the portion is a coil end portion which does not contribute to the rotational force of the motor 1 even when current flows. That is, no matter how the coil end portion is configured, this does not affect the rotational force of the motor 1, so that it is understood also from this fact that there is no problem even when the order of the main windings is irregular and the coil end portion is non-symmetrical in the planar view. A portion of the wire material parallel to the shaft 4 and located in the slot 62 contributes to the rotational force of the motor 1.

Also, in the description above, a case where hooking is performed twice to all the commutator segments 51 and the main winding is formed twice in all the slots 62 is illustrated. From this state, by further repeating formation of the equalizing line and the main winding without cutting the wire material, hooking may be performed three times to all the commutator segments 51, and the main winding may be formed three times in all the slots 62. Note that, when hooking is performed twice, a state after fusing is more stable as compared with that in a case of hooking more than two times.

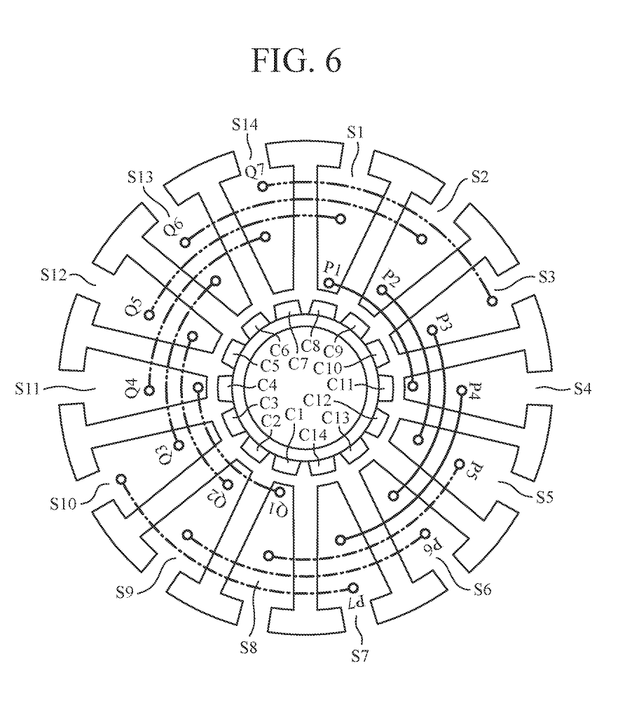

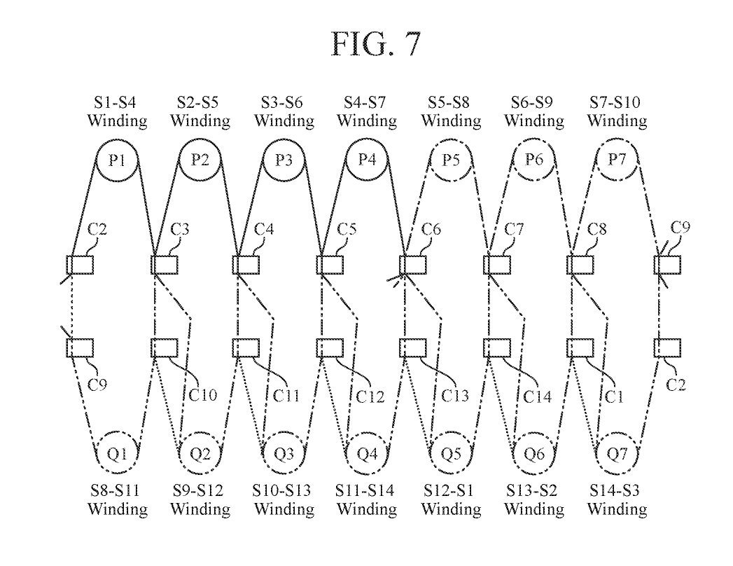

Herein, FIG. 6 illustrates states of main windings of a motor which is a first reference example for assisting understanding of the motor 1. FIG. 7 is a view illustrating the order of winding in the first reference example. In the motor according to the first reference example, the configurations other than winding such as the brush 7 and the magnet 9 are the same as those illustrated in FIG. 1.

In the first reference example, winding is started at the commutator segment C2, then a main winding P1 is formed between the slots S1 and S4, then hooking is performed to the commutator segment C3, then a main winding P2 is formed between the slots S2 and S5, then hooking is performed to the commutator segment C4, then a main winding P3 is formed between the slots S3 and S6, then hooking is performed to the commutator segment C5, then a main winding P4 is formed between the slots S4 and S7, and then hooking is performed to the commutator segment C6. Winding ends at the commutator segment C6, and thus the processes from the start of winding at the commutator segment C2 to the end of winding at the commutator segment C6 are performed with one wire material indicated by solid line in FIGS. 6 and 7.

Subsequently, winding is started at the commutator segment C9, then a main winding Q1 is formed between the slots S8 and S11, then hooking is performed to the commutator segment C10 and then to the commutator segment C3, then a main winding Q2 is formed between the slots S9 and S12, then hooking is performed to the commutator segment C11 and then to the commutator segment C4, then a main winding Q3 is formed between the slots S10 and S13, then hooking is performed to the commutator segment C12 and then to the commutator segment C5, then a main winding Q4 is formed between the slots S11 and S14, then hooking is performed to the commutator segment C13 and then to the commutator segment C6, then a main winding Q5 is formed between the slots S12 and S1, then hooking is performed to the commutator segment C14 and then to the commutator segment C7, then a main winding Q6 is formed between the slots S13 and S2, then hooking is performed to the commutator segment C1 and then to the commutator segment C8, then a main winding Q7 is formed between the slots S14 and S3, and then hooking is performed to the commutator segment C2 and then to the commutator segment C9. Winding ends at the commutator segment C9, and thus the processes from the start of winding at the commutator segment C9 to the end of winding at the commutator segment C9 are performed with one wire material indicated by dashed-two dotted line in FIGS. 6 and 7.

Subsequently, winding is started at the commutator segment C6, then a main winding P5 is formed between the slots S5 and S8, then hooking is performed to the commutator segment C7, then a main winding P6 is formed between the slots S6 and S9, then hooking is performed to the commutator segment C8, then a main winding P7 is formed between the slots S7 and S10, and then hooking is performed to the commutator segment C9. Winding ends at the commutator segment C9, and thus the processes from the start of winding at the commutator segment C6 to the end of winding at the commutator segment C9 are performed with one wire material indicated by dashed-dotted line in FIGS. 6 and 7.

Note that a broken line connecting the commutator segment C2 and the commutator segment C9 located at the left end in FIG. 7 indicates an equalizing line drawn with solid line and connecting the commutator segment C2 and the commutator segment C9 located at the right end in FIG. 7.

Also, a dotted line connecting the commutator segment C10 and the main winding Q2 in FIG. 7 indicates that, after the wire material is passed from the main winding Q1 to the commutator segment C10 and then to the commutator segment C3, this may be hooked again to the commutator segment C10 to form the main winding Q2. The same applies to other dotted lines.

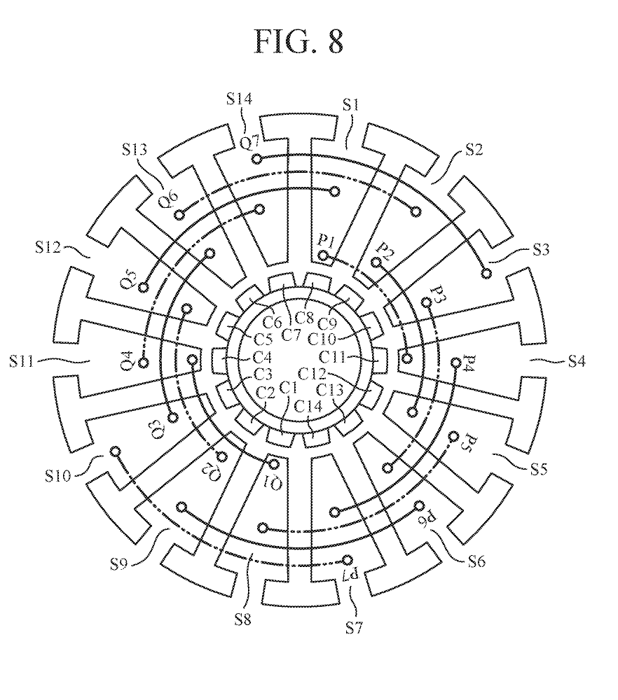

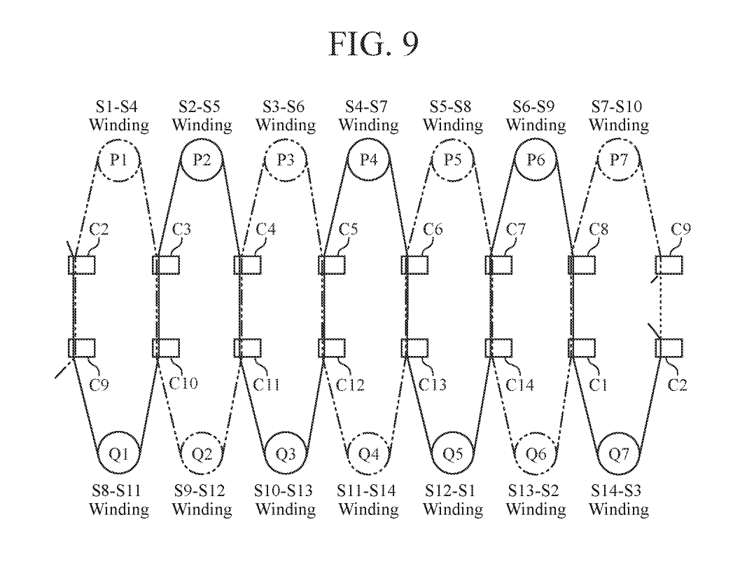

FIG. 8 illustrates states of main windings of a motor which is a second reference example for assisting understanding of the motor 1. FIG. 9 is a view illustrating the order of winding in the second reference example. The second reference example is so-called as double flyer winding. In the motor according to the second reference example, the configurations other than winding such as the brush 7 and the magnet 9 are the same as those illustrated in FIG. 1.

In the double flyer winding, winding one wire material indicated by dashed-two dotted line and winding another wire material indicated by solid line in FIG. 8 and FIG. 9 are performed at the same time in parallel.

Winding the wire material indicated by dashed-two dotted line is started at the commutator segment C9, then hooking is performed to the commutator segment C2, then a main winding P1 is formed between the slots S1 and S4, then hooking is performed to the commutator segment C3 and then to the commutator segment C10, then a main winding Q2 is formed between slots S9 and S12, then hooking is performed to the commutator segment C11 and then to the commutator segment C4, then a main winding P3 is formed between the slots S3 and S6, then hooking is performed to the commutator segment C5 and then to the commutator segment C12, then a main winding Q4 is formed between the slots S11 and S14, then hooking is performed to the commutator segment C13 and then to the commutator segment C6, then a main winding P5 is formed between the slots S5 and S8, then hooking is performed to the commutator segment C7 and then to the commutator segment C14, then a main winding Q6 is formed between the slots S13 and S2, then hooking is performed to the commutator segment C1 and then to the commutator segment C8, then a main winding P7 is formed between the slots S7 and S10, and then hooking is performed to the commutator segment C9. Winding ends at the commutator segment C9.

Winding the wire material indicated by solid line is started at the commutator segment C2, then hooking is performed to the commutator segment C9, then a main winding Q1 is formed between the slots S8 and S11, then hooking is performed to the commutator segment C10 and then to the commutator segment C3, then a main winding P2 is formed between the slots S2 and S5, then hooking is performed to the commutator segment C4 and then to the commutator segment C11, then a main winding Q3 is formed between the slots S10 and S13, then hooking is performed to the commutator segment C12 and then to the commutator segment C5, then a main winding P4 is formed between the slots S4 and S7, then hooking is performed to the commutator segment C6 and then to the commutator segment C13, then a main winding Q5 is formed between the slots S12 and S1, then hooking is performed to the commutator segment C14 and then to the commutator segment C7, then a main winding P6 is formed between the slots S6 and S9, then hooking is performed to the commutator segment C8 and then to the commutator segment Cl, then a main winding Q7 is formed between the slots S14 and S3, and then hooking is performed to the commutator segment C2. Winding ends at the commutator segment C2.

Note that a broken line connecting the commutator segment C2 and the commutator segment C9 located at the right end in FIG. 9 indicates equalizing lines drawn with solid line and dashed-two dotted line and connecting the commutator segment C2 and the commutator segment C9 located at the left end in FIG. 9.

In the first reference example illustrated in FIGS. 6 and 7, winding is performed using three wire materials, so that winding starts and ends at three points. Thus, it is necessary to cut the wire materials three times; once at the commutator segment C6 and twice at the commutator segment C9. Also, in the second reference example illustrated in FIGS. 8 and 9, winding is performed using two wire materials, so that winding starts and ends at two points. Thus, it is necessary to cut the wire materials twice; once at the commutator segment C2 and once at the commutator segment C9. When the number of times the wire material is cut in the winding process is large in this manner, it takes time, and quality is not stable because the necessity of a plurality of processes of starting and ending winding makes possibility of making a mistake in hooking increase. In a case of the double flyer winding, since the two wire materials are wound at the same time, production efficiency is somewhat high, but equipment such as a winding machine is expensive, complicated, and large. In addition, a plurality of processes of starting and ending winding is still required.

On the other hand, in the motor 1 of the first embodiment, the main winding and the equalizing line are formed of one wire material, and thus winding starts and ends only at one point. Therefore, it is possible to shorten the time required for the winding process, and it is possible to stabilize the quality by suppressing the possibility of making a mistake in hooking.

In the first reference example illustrated in FIGS. 6 and 7, the number of times of hooking is one in the commutator segments C1, and C10 to C14, the number of times of hooking is two in the commutator segments C2 to C5, C7, and C8, and the number of times of hooking is three in the commutator segments C6 and C9. In the second reference example illustrated in FIGS. 8 and 9, the number of times of hooking is two in the commutator segments C1, C3 to C8, and C10 to C14, and the number of times of hooking is three in the commutator segments C2 and C9. The commutator segments C1 to C14 and the equalizing line are joined by performing a fusing process on the hook 51a. However, when the number of times of hooking varies depending on the commutator segment, it is necessary to change setting of fusing each time. Therefore, it is necessary to perform fusing while confirming how many times hooking is performed to the commutator segment, which complicates the process. As the process becomes complicated, quality becomes difficult to be stabilized.

On the other hand, in the motor 1 of the first embodiment, the number of times of hooking to each of the commutator segments C1 to C14 is the same, two in the illustrated example. That is, the state of hooking is similar in all the commutator segments 51. Therefore, it is possible to perform fusing on all the commutator segments 51 without changing the setting of fusing, thus the process is simplified, and thus the quality is stabilized.

The main winding R3 and the main winding R10 of the motor 1 illustrated in FIGS. 3, 4, and 5 respectively correspond to the main winding P1 and the main winding Q1 of the first reference example and the second reference example illustrated in FIGS. 6, 7, 8, and 9. The commutator segments 51 to which these main windings are connected are, in any case of the motor 1, the first reference example and the second reference example, the commutator segments C2, C9, C3, and C10.

Similarly, the main winding R4 and the main winding R11 of the motor 1 correspond to the main winding P2 and the main winding Q2 of the first reference example and the second reference example. Similarly, the main winding R5 and the main winding R12 of the motor 1 correspond to the main winding P3 and the main winding Q3 of the first reference example and the second reference example. Similarly, the main winding R6 and the main winding R13 of the motor 1 correspond to the main winding P4 and the main winding Q4 of the first reference example and the second reference example. Similarly, the main winding R7 and the main winding R14 of the motor 1 correspond to the main winding P5 and the main winding Q5 of the first reference example and the second reference example. Similarly, the main winding R1 and the main winding R8 of the motor 1 correspond to the main winding P6 and the main winding Q6 of the first reference example and the second reference example. Similarly, the main winding R2 and the main winding R9 of the motor 1 correspond to the main winding P7 and the main winding Q7 of the first reference example and the second reference example.

That is, the winding of the motor 1 is a circuit similar to that of each of the first reference example and the second reference example, and thus it is understood that equivalent performance as a motor can be obtained.

The main windings P1 and Q1 of the first and second reference examples and the main windings R3 and R10 of the motor 1 corresponding to them are different in the order of forming. Therefore, although the main windings P1 and Q1 are located on the innermost side as illustrated in FIGS. 6 and 8, the main windings R3 and R10 are not located on the innermost side as illustrated in FIG. 3. That is, the positions of the corresponding main windings are not the same, and thus a length of the coil end portion is different between the first and second reference examples and the motor 1. However, as already described, since the coil end portion does not contribute to the rotational force, there is no problem and equivalent performance can be obtained when the circuit is similar.

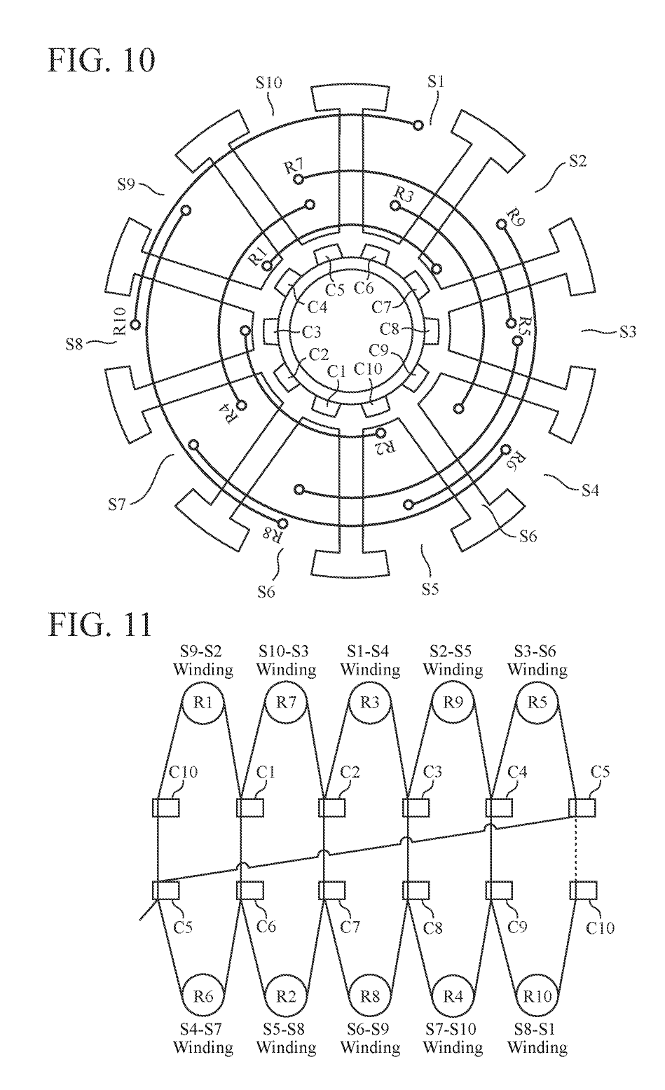

FIGS. 10 and 11 are views illustrating the winding process in a case where ten commutator segments 51 and ten teeth 61 are provided.

In order not to repeat things described above with reference to FIGS. 3, 4, and 5, the following is briefly described.

Winding is started at a commutator segment C5, then hooking is performed to a commutator segment C10, then a main winding R1 is formed between slots S9 and S2, then hooking is performed to a commutator segment C1 and then to a commutator segment C6, then a main winding R2 is formed between slots S5 and S8, then hooking is performed to a commutator segment C7 and then to a commutator segment C2, then a main winding R3 is formed between slots S1 and S4, then hooking is performed to a commutator segment C3 and then to a commutator segment C8, then a main winding R4 is formed between slots S7 and S10, then hooking is performed to a commutator segment C9 and then to a commutator segment C4, then a main winding R5 is formed between slots S3 and S6, then hooking is performed to the commutator segment C5, then a main winding R6 is formed between the slots S4 and S7, then hooking is performed to the commutator segment C6 and then to the commutator segment C1, then a main winding R7 is formed between the slots S10 and S3, then hooking is performed to the commutator segment C2 and then to the commutator segment C7, then a main winding R8 is formed between the slots S6 and S9, then hooking is performed to the commutator segment C8 and then to the commutator segment C3, then a main winding R9 is formed between the slots S2 and S5, then hooking is performed to the commutator segment C4 and then to the commutator segment C9, then a main winding R10 is formed between the slot S8 and the slot S1, and then hooking is performed to the commutator segment C10. Winding ends at the commutator segment C10.

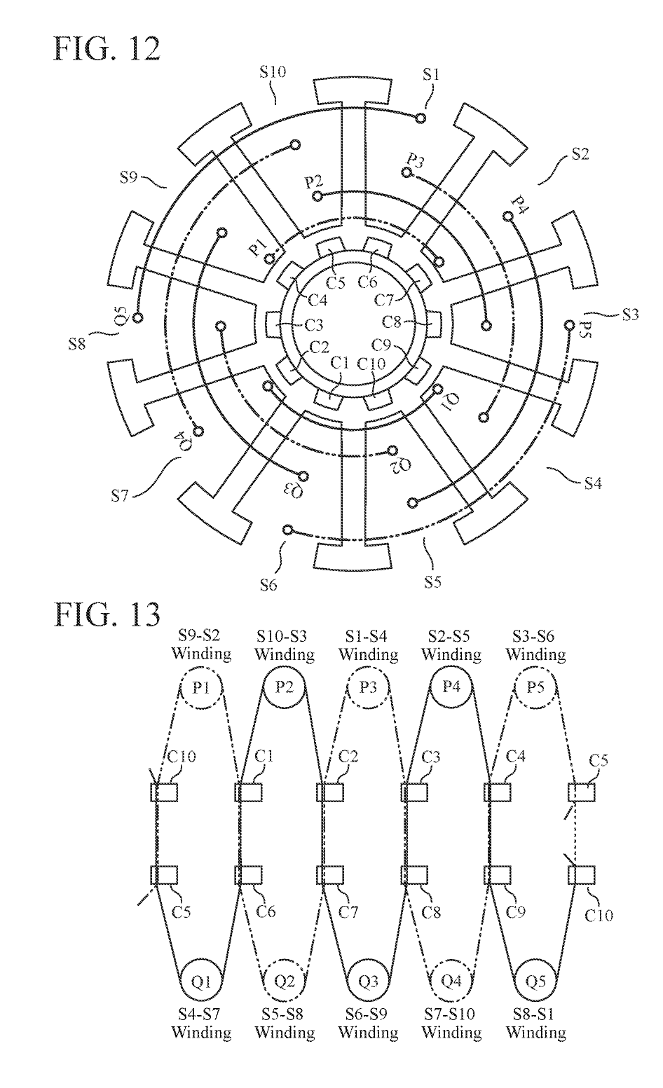

FIGS. 12 and 13 illustrate a third reference example with double flyer winding in a case where ten commutator segments 51 and ten teeth 61 are provided.

Winding a wire material indicated by dashed-two dotted line is started at the commutator segment C5, then hooking is performed to the commutator segment C10, then a main winding P1 is formed between the slots S9 and S2, then hooking is performed to the commutator segment CI and then to the commutator segment C6, then a main winding Q2 is formed between the slots S5 and S8, then hooking is performed to the commutator segment C7 and then to the commutator segment C2, then a main winding P3 is formed between the slots S1 and S4, then hooking is performed to the commutator segment C3 and then to the commutator segment C8, then a main winding Q4 is formed between the slots S7 and S10, then hooking is performed to the commutator segment C9 and then to the commutator segment C4, then a main winding P5 is formed between the slots S3 and S6, and then hooking is performed to the commutator segment C5. Winding ends at the commutator segment C5.

Winding a wire material indicated by solid line is started at the commutator segment C10, then hooking is performed to the commutator segment C5, then a main winding Q1 is formed between the slots S4 and S7, then hooking is performed to the commutator segment C6 and then to the commutator segment C1, then a main winding P2 is formed between the slots S10 and S3, then hooking is performed to the commutator segment C2 and then to the commutator segment C7, then a main winding Q3 is formed between the slots S6 and S9, then hooking is performed to the commutator segment C8 and then to the commutator segment C3, then a main winding P4 is formed between the slots S2 and S5, then hooking is performed to the commutator segment C4 and then to the commutator segment C9, then a main winding Q5 is formed between the slots S8 and S1, and then hooking is performed to the commutator segment C10. Winding ends at the commutator segment C10.

As is clear from FIGS. 10 and 11, the main winding and the equalizing line are formed of one wire material, and thus winding is started and ended only at one point. As is clear from FIGS. 10 and 11, the number of times of hooking to each of the commutator segments C1 to C10 is the same. Therefore, even in a case where ten commutator segments 51 and ten teeth 61 are provided, the effect similar to that in the above-described case where 14 commutator segments 15 and 14 teeth 61 are provided can be obtained.

In addition, it is understood that the winding illustrated in FIGS. 10 and 11 is a circuit similar to that in a case of the double flyer winding illustrated as the third reference example.

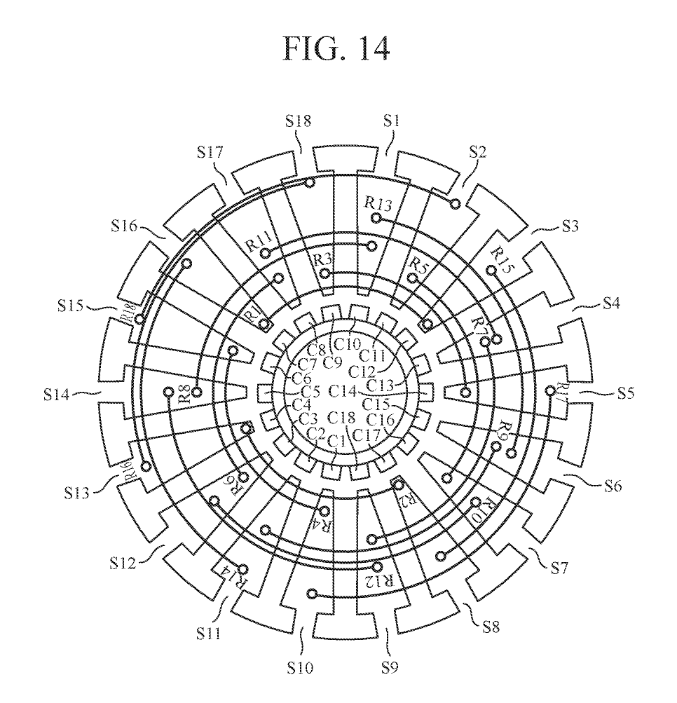

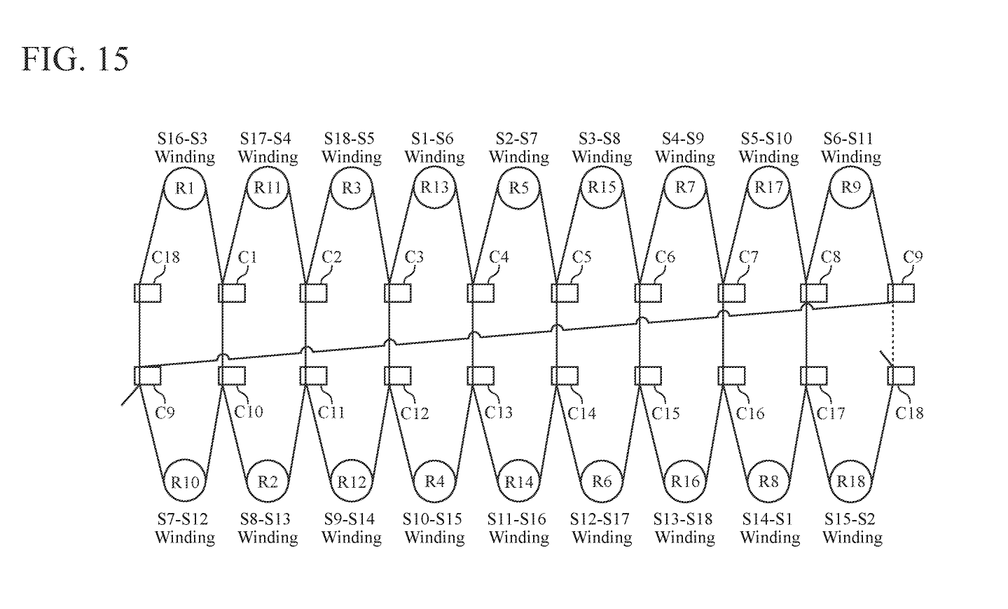

FIGS. 14 and 15 are views illustrating the winding process in a case where 18 commutator segments 51 and 18 teeth 61 are provided.

In order not to repeat things described above with reference to FIGS. 3, 4, and 5, the following is briefly described.

Winding starts at a commutator segment C9, then hooking is performed to a commutator segment C18, then a main winding R1 is formed between slots S16 and S3, then hooking is performed to a commutator segment C1 and then to a commutator segment C10, then a main winding R2 is formed between a slot S8 and a slot S13, then hooking is performed to a commutator segment C11 and then to a commutator segment C2, then a main winding R3 is formed between a slot S18 and a slot S5, then hooking is performed to a commutator segment C3 and then to a commutator segment C12, then a main winding R4 is formed between a slot S10 and a slot S15, then hooking is performed to a commutator segment C13 and then to a commutator segment C4, then a main winding R5 is formed between a slot S2 and a slot S7, then hooking is performed to a commutator segment C5 and then to a commutator segment C14, then a main winding R6 is formed between a slot S12 and a slot S17, then hooking is performed to a commutator segment C15 and then to a commutator segment C6, then a main winding R7 is formed between a slot S4 and a slot S9, then hooking is performed to a commutator segment C7 and then to a commutator segment C16, then a main winding R8 is formed between a slot S14 and a slot S1, then hooking is performed to a commutator segment C17 and then to a commutator segment C8, then a main winding R9 is formed between a slot S6 and a slot S11, then hooking is performed to the commutator segment C9, then a main winding R10 is formed between the slot S7 and the slot S12, then hooking is performed to the commutator segment C10 and then to the commutator segment C1, then a main winding R11 is formed between the slot S17 and the slot S4, then hooking is performed to the commutator segment C2 and then to the commutator segment C11, then a main winding R12 is formed between the slot S9 and the slot S14, then hooking is performed to the commutator segment C12 and then to the commutator segment C3, then a main winding R13 is formed between the slot S1 and the slot S6, then hooking is performed to the commutator segment C4 and then to the commutator segment C13, then a main winding R14 is formed between the slot S11 and the slot S16, then hooking is performed to the commutator segment C14 and then to the commutator segment C5, then a main winding R15 is formed between the slot S3 and the slot S8, then hooking is performed to the commutator segment C6 and then to the commutator segment C15, then a main winding R16 is formed between the slot S13 and the slot S18, then hooking is performed to the commutator segment C16 and then to the commutator segment C7, then a main winding R17 is formed between the slot S5 and the slot S10, then hooking is performed to the commutator segment C8 and then to the commutator segment C17, then a main winding R18 is formed between the slot S15 and the slot S2, and then hooking is performed to the commutator segment C18. Winding ends at the commutator segment C18.

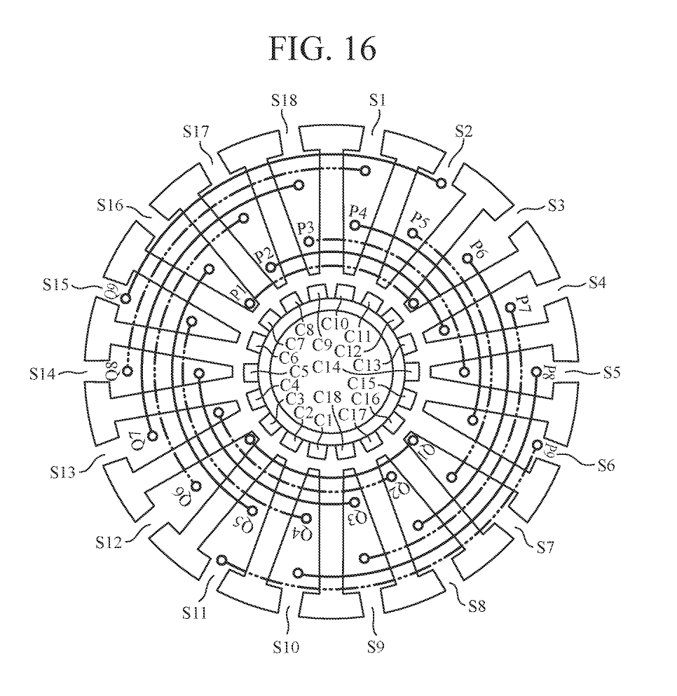

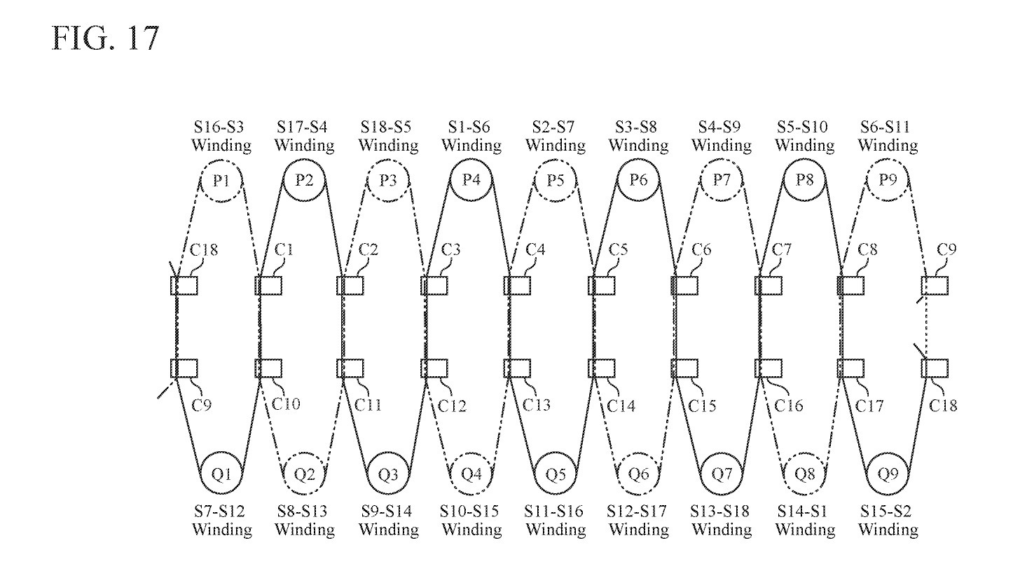

FIGS. 16 and 17 illustrate a fourth reference example with double flyer winding in a case where 18 commutator segments 51 and 18 teeth 61 are provided.

Winding a wire material indicated by dashed-two dotted line is started at the commutator segment C9, then hooking is performed to the commutator segment C18, then a main winding P1 is formed between the slots S16 and S3, then hooking is performed to the commutator segment C1 and then to the commutator segment C10, then a main winding Q2 is formed between the slots S8 and S13, then hooking is performed to the commutator segment C11 and then to the commutator segment C2, then a main winding P3 is formed between the slots S18 and S5, then hooking is performed to the commutator segment C3 and then to the commutator segment C12, then a main winding Q4 is formed between the slots S10 and S15, then hooking is performed to the commutator segment C13 and then to the commutator segment C4, then a main winding PS is formed between the slots S2 and S7, then hooking is performed to the commutator segment C5 and then to the commutator segment C14, then a main winding Q6 is formed between the slots S12 and S17, then hooking is performed to the commutator segment C15 and then to the commutator segment C6, then a main winding P7 is formed between the slots S4 and S9, then hooking is performed to the commutator segment C7 and then to the commutator segment C16, then a main winding Q8 is formed between the slots S14 and S1, then hooking is performed to the commutator segment C17 and then to the commutator segment C8, then a main winding P9 is formed between the slots S6 and S11, and then hooking is performed to the commutator segment C9. Winding ends at the commutator segment C9.

Winding a wire material indicated by solid line is started at the commutator segment C18, then hooking is performed to the commutator segment C9, then a main winding Q1 is formed between the slots S7 and S12, then hooking is performed to the commutator segment C10 and then to the commutator segment C1, then a main winding P2 is formed between the slots S17 and S4, then hooking is performed to the commutator segment C2 and then to the commutator segment C11, then a main winding Q3 is formed between the slots S9 and S14, then hooking is performed to the commutator segment C12 and then to the commutator segment C3, then a main winding P4 is formed between the slots S1 and S6, then hooking is performed to the commutator segment C4 and then to the commutator segment C13, then a main winding Q5 is formed between the slots S11 and S16, then hooking is performed to the commutator segment C14 and then to the commutator segment C5, then a main winding P6 is formed between the slots S3 and S8, then hooking is performed to the commutator segment C6 and then to the commutator segment C15, then a main winding Q7 is formed between the slots S13 and S18, then hooking is performed to the commutator segment C16 and then to the commutator segment C7, then a main winding P8 is formed between the slots S5 and S1 0, then hooking is performed to the commutator segment C8 and then to the commutator segment C17, then a main winding Q9 is formed between the slots S15 and S2, and then hooking is performed to the commutator segment C18. Winding ends at the commutator segment C18.

As is clear from FIGS. 14 and 15, the main winding and the equalizing line are formed of one wire material, and thus winding is started and ended only at one point. As is clear from FIGS. 14 and 15, the number of times of hooking to each of the commutator segments C1 to C18 is the same. Therefore, even in a case where 18 commutator segments 51 and 18 teeth 61 are provided, the effect similar to that in the above-described case where 14 commutator segments 51 and 14 teeth 61 are provided can be obtained.

In addition, it is understood that the winding illustrated in FIGS. 14 and 15 is a circuit similar to that in a case of the double flyer winding illustrated as the fourth reference example.

As described above, in the motor 1 according to the first embodiment, since the equalizing line and the main winding are integrally formed of one continuous wire material, the number of times the wire material is cut at the time of the winding process is suppressed. As a result, it is possible to shorten the time required for the winding process, and it is possible to stabilize the quality by suppressing the possibility of making a mistake in hooking.

Also, in the motor 1 according to the first embodiment, since the number of times of hooking to each of all the commutator segments 51 is the same, it is possible to perform fusing with the same setting. As a result, fusing is not complicated, and the quality of fusing can be stabilized.

In addition, the wire material is hooked twice to each of a plurality of commutator segments 51. When the number of times of hooking is two, the state after fusing is more stable.

In addition, an even number of a plurality of teeth 61 and an even number of a plurality of commutator segments 51 are provided. In the above description, the cases where the number of the teeth 61 and the number of the commutator segments 51 are ten, 14, and 18 are illustrated; however, even in another case where 20 teeth 61 and 20 commutator segments 51 are provided, for example, the first embodiment is applicable.

Meanwhile, in the invention of the present application, any component of the embodiment may be modified, or any component of the embodiment may be omitted without departing from the scope of the invention.

### INDUSTRIAL APPLICABILITY

As described above, in the motor according to the present invention, the number of times the wire material is cut at the time of the winding process is suppressed and fusing with the same setting can be performed on all the commutator segments. Thus, the motor according to the present invention is suitable for use as a motor that requires stable quality, such as an in-vehicle motor.

### REFERENCE SIGNS LIST

1: Motor, 2: Case, 3: Brush holder, 4: Shaft, 5: Commutator, 6: Rotor core, 7: Brush, 8: Coil, 9: Magnet, 10: Yoke, 51: Commutator segment, 51a: Hook, 61: Teeth, 62: Slot

1. A motor comprising:
a rotatable shaft;
a rotor core including a plurality of teeth which are provided side by side in a circumferential direction with respect to a rotation axis direction of the shaft, a plurality of slots being formed between respective pairs of the adjacent teeth, the rotor core fixed to the shaft;
a commutator including a plurality of commutator segments which are as many as the plurality of teeth and provided side by side in the circumferential direction with respect to the rotation axis direction of the shaft, the commutator fixed to the shaft;
an equalizing line that connects diagonally located commutator segments out of the plurality of commutator segments; and
a main winding wound between each of the plurality of slots and another one of the slots in a distributed manner,
wherein an equalizing line is hooked to each of the plurality of commutator segments a same number of times,
the equalizing line and the main winding are integrally formed of one continuous wire material, and
there is a portion which is a portion of the wire material and hooked to corresponding one of the commutator segments between a main winding wound in a distributed manner between two of the slots and a main winding wound in a distributed manner between other two of the slots.

2. The motor according to claim 1,
wherein the wire material is hooked twice to each of the plurality of commutator segments.

3. The motor according to claim 1,
wherein an even number of the plurality of teeth and an even number of the plurality of commutator segments are provided.

4. A winding method for the motor according to claim 1, comprising:
a first process of hooking the wire material to one of the commutator segments and then hooking the wire material to another one of the commutator segments diagonally located to the one of the commutator segments to form an equalizing line;
a second process of passing the wire material to one of the slots, and winding the wire material in a distributed manner between the one of the slots and another one of the slots to form a main winding; and
a third process of, when the wire material is hooked to the two commutator segments and the main winding is formed between the two slots, changing targets of the commutator segments to which hooking is to be performed and targets of the slots in which a main winding is to be formed, wherein the first process is repeated for each of the commutator segments until a number of times of hooking to each of the commutator segments is same, the second process is repeated for each of the slots until a number of times a main winding is formed in each of the slots is same, and a portion which is a portion of the wire material and hooked to corresponding one of the commutator segments is formed between the main winding wound in a distributed manner between the two slots and a main winding to be wound in a distributed manner next between other two of the slots.
